(19) United States
(12) Patent Application Publication
(10) Pub. No.: US 2018/0225767 A1
(43) Pub. Date: Aug. 9, 2018

(54) INVESTMENT MANAGEMENT PROPOSAL SYSTEM

(71) Applicant: NOMURA RESEARCH INSTITUTE, LTD., Tokyo (JP)

(72) Inventors: Tatsuo TANAKA, Tokyo (JP); Yoshinobu HIGUCHI, Tokyo (JP); Kazuo SUZUOKI, Tokyo (JP); Yoshihito ASO, Tokyo (JP); Hiroyuki NAKAMURA, Tokyo (JP)

(73) Assignee: NOMURA RESEARCH INSTITUTE, LTD., Tokyo (JP)

(21) Appl. No.: 15/947,253

(22) Filed: Apr. 6, 2018

Related U.S. Application Data
(63) Continuation of application No. PCT/JP2015/078562, filed on Oct. 8, 2015.

(51) Int. Cl. G06Q 40/06; G06Q 10/04

(52) U.S. Cl. CPC G06Q 40/06; G06Q 10/04

(57) ABSTRACT

Provided is an investment management proposal system that proposes a suitable investment management algorithm and portfolio which flexibly respond to the diverse needs of an investor. A representative embodiment of the present invention is an investment management proposal system that proposes, to a user, investment management in respect to a financial product, the investment management proposal system having a plurality of types of prerecorded algorithms pertaining to investment management which can be called from a program, and having a determination engine which receives the input of information pertaining to an investment stance from the user and selects at least one suitable algorithm on the basis of the input investment stance information.

### BACKGROUND

### Technical Field

The present invention relates to a technique for assisting the investment management of financial products, in particular to a technique effectively applied to an investment management proposal system that assists financial institutions and the like in offering advice and proposals on investment to investors.

### Related Art

For example, financial institutions and the like may offer advice and proposals on investment and asset management to individual investors and others as business operations. Some mechanisms for assisting such business operations by an information processing system have been suggested. In addition, services called “robo-advisor” for automatically assisting investment management and portfolio management have been expanding mainly in Europe and the United States.

For example, Hedgeable, Inc. (https://www.hedgeable.com/), a U.S. financial services company, has already offered their “robo-advisor” services. In such services, for example, a customer answers several questions about investment purposes, investment principle, asset situation, and others on a screen in a Web application, and then preferred portfolios are recommended as needed to the customer in accordance with the answers and others. When the customer selects investment management with one of the portfolios, the assets will be automatically managed in accordance with the portfolio.

As a technique relating to proposal of recommended portfolios and automatic management in accordance with portfolios, for example, JP 2000-293569 A describes a method for offering proposals of portfolios with combinations of a plurality of financial products for a predetermined management period. According to this method, a plurality of scenarios of changes in the market prices of financial products is set in advance in a systematic way, parameters representing the change scenarios and parameters representing the market characteristics are used to simulate future profits and losses for the individual change scenarios, and an optimal portfolio is arranged from a set of narrowed portfolios and suggested to the customer.

JP 2014-525062 A describes a technique relating to a system for portfolio building by receiving risk tolerance data indicating an investor's risk tolerance level and investment selection criteria from a user terminal, generating a list of possible investment destinations to be included in portfolios, ranked according to the investment selection criteria, and displaying the list on the user terminal.

JP 2008-243158 A describes a portfolio automatic management system that is capable of automatically issuing trading orders according to a portfolio management algorithm. The system includes a management program posting system, a performance display unit that displays simulated investment income performance, a unit for a customer to select a preferred one of a plurality of portfolio management algorithms, a unit for the user to set the actual investment amount for the selected algorithm, and a selection unit for execution/stop of automatic management.

### SUMMARY

According to the conventional techniques described in JP 2000-293569 A and JP 2014-525062 A and other portfolio building and management services, for example, it is possible to build and manage automatically a portfolio according to a predetermined algorithm. In these services, the modern portfolio theory (MPT) is generally used as an algorithm. According to this algorithm, no hedge is made against risk in the middle of investment. Meanwhile, some of the “robo-advisor” services have unique algorithms allowing a risk hedge such as the services provided by Hedgeable, Inc., for example. In either case, however, only one algorithm is employed in each of the services, which makes it difficult to respond flexibly to individual investors' needs in a single service.

According to the conventional technique described in JP 2008-243158 A, investors can select one of the plurality of portfolio management algorithms according to their needs. However, this technique requires the individual investors to determine a preferred one of the algorithms by themselves with reference to simulation results and others, which does not constitute a sufficient mechanism for recommending and proposing preferred algorithms.

An object of the present invention is to provide an investment management proposal system that responds flexibly to investors' various needs and proposes preferred investment management algorithms and portfolios.

The foregoing and other objects and novel characteristics of the present invention will be clarified from the descriptions herein and the attached drawings.

Representative embodiment of the invention disclosed in the present application will be briefly described as follows.

An investment management proposal system according to a representative embodiment of the present invention is an investment management proposal system that offers proposals for investment management of financial products to a user. The investment management system includes a plurality of kinds of pre-registered algorithms relating to investment management and capable of being invoked from a program and a determination engine that accepts an input of information relating to an investment stance from the user and selects preferred one or more of the algorithms based on the input information on the investment stance.

The advantageous effect of the representative embodiment of the invention disclosed in the present application will be briefly described as follows:

According to the representative embodiment of the present invention, it is possible to respond flexibly to investors' various needs and propose preferred investment management algorithms and portfolios.

### BRIEF DESCRIPTION OF DRAWINGS

FIG. 1 is a schematic diagram illustrating a configuration example of an investment management proposal system according to an embodiment of the present invention;

FIG. 2 is a flowchart outlining an example of an process performed by a determination engine in an embodiment of the present invention; and

FIG. 3 is a flowchart outlining an example of an process performed by a determination engine in an embodiment of the present invention.

### DETAILED DESCRIPTION

Embodiments of the present invention will be described below in detail. In all the drawings for describing the embodiments, identical components will be given identical reference signs and repeated descriptions thereof will be omitted. Meanwhile, an component described with a reference sign in relation to one drawing may be mentioned again with the same reference sign in the description in relation to other drawings in which the component is not illustrated.

### <System Configuration>

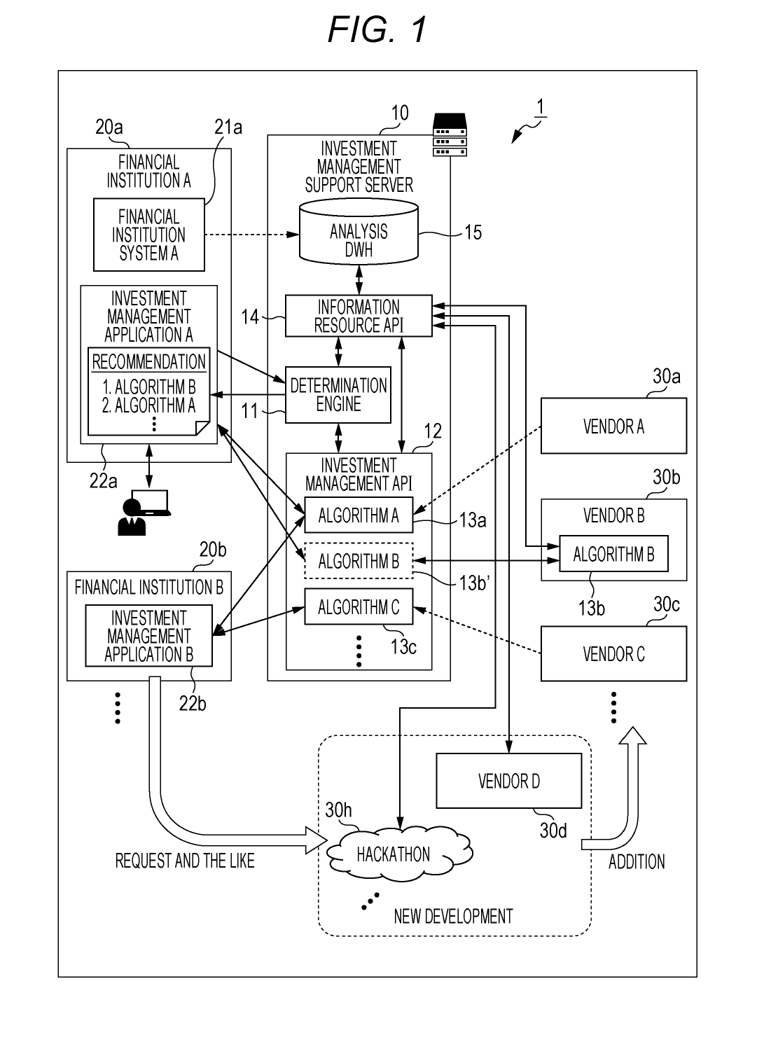

FIG. 1 is a schematic diagram illustrating a configuration example of an investment management proposal system according to an embodiment of the present invention. An investment management proposal system 1 in the embodiment is configured, for example, such that an investment management assistance server 10 releases and provides to one or more financial institutions (in the example of FIG. 1, a financial institution A (20a), a financial institution B (20b), and the like, hereinafter also collectively called financial institution 20) a plurality of kinds of usable investment management algorithms implemented in the form of an investment management application programming interface (API) 12 (in the example of FIG. 1, an algorithm A (13a), algorithms B (13b and 13b′), an algorithm C (13c), and the like, hereinafter also collectively called algorithm 13).

In each of the financial institutions 20, an application program (in the example of FIG. 1, an investment management application A (22a), an investment management application B (22b), or the like, hereinafter also collectively called investment management application 22) used to offer services for giving proposals and advice on portfolios of diversified investment to investors and customers (hereinafter also called users) invokes the investment management API 12 according to the algorithms 13 recommended by the investment management assistance server 10 to respond flexibly to users' various needs and use the suitable algorithms 13.

The investment management assistance server 10 is a server system including one or more server devices and one or more virtual servers built in a cloud computing service. The investment management assistance server 10 has a determination engine 11 that is implemented by software running on middleware such as an operating system (OS), database management system (DBMS), or Web server program, an investment management API 12, and an information resource API 14. The investment management assistance server 10 also has an analysis data warehouse (DWH) 15 implemented as a database.

The analysis DWH 15 extracts, acquires, and accumulates information on investment products sold by the financial institution 20, user attribute information, account transaction history information, access history information, and others, if possible, from an account-based/information-based nformation processing system possessed by the financial institution 20 (in the example of FIG. 1, a financial institution system A (21a) of the financial institution A (20a), hereinafter also collectively called financial institution system 21) possessed by the financial institution 20, on a regular basis by daily operation or the like. When the financial institution 20 has no information processing system capable of cooperation, various kinds of information may be manually registered with the analysis DWH 15. In addition, performance information on past price action and rating of each stock may be acquired and accumulated from external data sources or the like, for example. The information accumulated in the analysis DWH 15 can be acquired and referred to from other programs via the information resource API 14.

The determination engine 11 accepts a request from the investment management application 22 operated by the financial institution 20 via a network not illustrated, ranks the registered algorithms 13 (or combinations of algorithms 13 and portfolio types) by a process as described later based on information relating to the user acquired from the investment management application 22, attribute information and transaction information on the user, and past performance information for individual stocks acquired via the information resource API 14 and accumulated in the analysis DWH 15, and returns a list of the recommended algorithms 13.

The investment management API 12 is an API group corresponding to the plurality of registered investment and management algorithms 13 for allowing the algorithms 13 to be individually invoked from other programs. Each of the algorithms 13 is intended to execute unique processes relating to investment management proposals according to its contents while acquiring and referring to various kinds of information accumulated in the analysis DWH 15 via the information resource API 14.

When acquiring the list of recommended algorithms 13 from the determination engine 11, the investment management application 22 invokes the investment management API 12 according to the algorithm 13 selected by the user from the list or the algorithm 13 automatically decided by the investment management application 22 or the determination engine 11. Accordingly, it is possible to offer the user a portfolio building and management service according to the desired algorithm 13.

In the example of FIG. 1, the user uses an information processing terminal to access the investment management application 22 including a Web application and the like provided by the financial institution 20 the user utilizes via a network not illustrated and obtain the portfolio building and management service. However, the investment management proposal system is not limited to this configuration. For example, the user may install an application equivalent to the investment management application 22 into their information processing terminal to access directly the investment management assistance server 10 without the intervention of the financial institution 20 and obtain the portfolio building service.

The algorithms 13 of the investment management API 12 are developed and provided by IT vendors, for example (in the example of FIG. 1, a vendor A (30a), a vendor B (30b), and a vendor C (30c), hereinafter also collectively called vendor 30). In the example of FIG. 1, the algorithm A (13a), the algorithm B (13b), and the algorithm C (13c) of the investment management API 12 are provided respectively by the vendor A (30a), the vendor B (30b), and the vendor C (30c).

Each of the algorithms 13 is not particularly limited in specific implementation as far as it has a standard interface as the investment management API 12 but can be arbitrarily implemented by the vendor 30. The investment management assistance server 10 may hold the contents and features of the usable algorithms 13 registered as the investment management API 12, interface information such as parameters for invoking, and others as catalog information not illustrated so that the financial institutions 20 operating the investment management applications 22 can refer to the catalog information.

The investment management assistance server 10 may hold the substance of the investment management API 12 (that is, program modules, libraries, and others) such as the algorithm A (13a) and the algorithm C (13c) so that they can run on the investment management assistance server 10, or the information processing system of the vendor B (30b) may hold the substance of the investment management API 12 such as the algorithm B (13b) and the investment management assistance server 10 may have only the interface (the algorithm (13b′) in FIG. 1) so that the substance of the algorithm B (13b) can be accessed via a network not illustrated.

In the example of FIG. 1, the vendors 30 provide and register one each algorithm 13 as the investment management API 12. Alternatively, one vendor 30 may provide and register a plurality of algorithms 13. In addition, for example, new algorithms 13 may be developed in development events and projects (or the vendors 30) such as hackathon 30h requested or funded by another vendor D (30d) or the financial institution 20 (in the example of the financial institution B (20b)) using the data accumulated in the analysis DWH 15 via the released information resource API 14, and added to the lineup of algorithms 13 in the investment management API 12. This makes it possible to promote increase in variations of the algorithm 13.

As described above, in the embodiment, the financial institutions 20 can invoke a plurality of different kinds of algorithms 13 provided by the vendors 30 to the investment management assistance server 10 in the form of the investment management API 12 from the investment management application 22 operated by themselves. That is, the investment management proposal system 1 in the embodiment is not a mere portfolio advising tool to the user but also serves as a matching platform for the financial institutions 20 selling investment products and the vendors 30 proposing methods for promoting sales of investment products.

### <Flow of Processing>

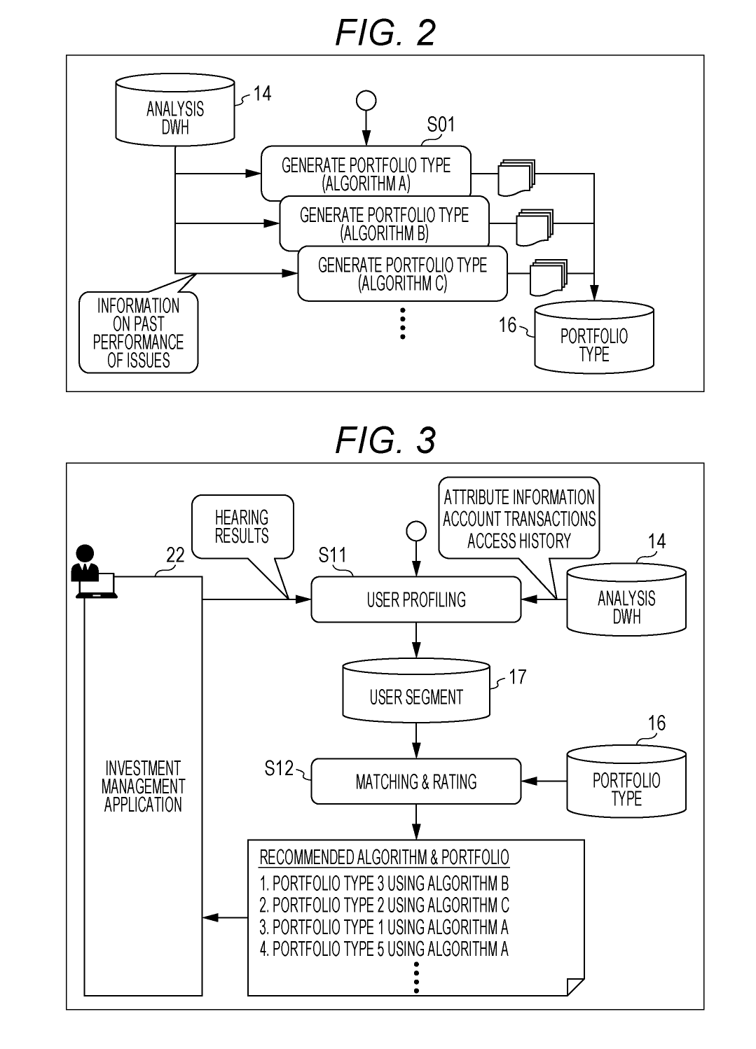

FIGS. 2 and 3 are flowcharts outlining examples of processes performed by the determination engine 11 in the investment management assistance server 10. FIG. 2 illustrates an example of a flow of a preliminary analysis process. In this case, without relation to the user information, the determination engine 11 creates a preferable portfolio in advance for each of the registered investment management algorithms 13 based on the past performance information on individual issues.

Specifically, for each of the registered algorithms 13, the determination engine 11 extracts the performance information such as past price actions, fundamentals, and ratings in the market on individual target issues from the analysis DWH 15 via the information resource API 14, and creates one or more portfolio types (patterns) by predetermined simulation or the like (S01). The determination engine 11 holds the created portfolio types (combinations of algorithms 13 and portfolios) as portfolio types 16 in the database or the like (S01). The determination engine 11 performs this process on a regular basis by daily operation or the like to reflect the latest performance information.

FIG. 3 illustrates an example of a flow of a process for returning the recommended algorithm 13 and portfolio types in response to the user request. In this case, first, the determination engine 11 acquires the results of hearing from users from the investment management application 22, extracts target user attribute information, account transaction information, and access history information from the analysis DWH 15, and performs user profiling to classify the users into a plurality of segments by investment type according to predetermined standards based on the extracted information (S11).

The information on the hearing results acquired from the investment management application 22 includes, but not be particularly limited to, the user's target investment amount, target investment period, monthly investment amount, risk tolerance, and annual income as information on user investment stance, for example. The hearing with the user is conducted, for example, such that the user enters answers in sequence into the question screen provided by the investment management application 22 on the user's information processing terminal or the like.

The information extracted from the analysis DWH 15 includes, but not be particularly limited to, user attribute information such as age, account transaction information from which trading tendencies and characteristics can be grasped such as traded issues and the frequency and timing of trading activity, and access history information from which the degree of interest and relation in market information such as the frequency and timing of access to the financial institution system 21, for example.

As an example of profiling, the user's amount of experience can be estimated from the information on the user's age and frequency of trading activity. In addition, the user's investment tendencies can be estimated from the information on the traded issues, for example, whether the user prefers investment in emerging countries or stable investment in Europe and the United States, or whether the user prefers investment in red ocean fields or blue ocean fields. When the estimated investment tendencies do not match the information on the risk tolerance acquired by hearing (for example, the user's answer is “prefer stable investment at a low risk tolerance” at the time of hearing, but the actually many of traded stock issues are from emerging countries), the contents of the recommended portfolio may be corrected in a process described later according to the results of estimation based on the actual history information (for example, increasing a little investment in emerging countries).

In addition, the user's attitude toward risk can be estimated from the information on trading timing (for example, whether the user sells immediately with a decline in the market price or sell after waiting and seeing the situation for a while). Further, the user's degree of interest in the market can be estimated by grasping at what timing the user watches the market from the information on access history (for example, on a regular basis such as every day or only with a change in the market price).

From the foregoing profiling, a user profile including the information on investment stance is created, for example, such as “Has many years of investment experience and high trading amount. Invests also in high-risk issues but makes quick decisions on trading with a sensitive reaction to market price movements (slightly low in risk tolerance). The target amount is high but the time limit is ten years after”. In step S11, users are given scores based on the contents of the user profiling according to predetermined conditions and criteria, and are classified into several investment types based on the scores. The information on the classification results is held as a user segment 17 in the database or the like.

After that, the classified user investment type is compared to the portfolio information for each of the investment management algorithms 13 created in advance according to the process flow described in FIG. 2 to rate (rank) the algorithms 13 and the portfolios according to predetermined criteria and conditions on whether the algorithms 13 and the portfolios match the user's investment type (S12). For example, a condition for matching the investment type is set such as “recommending a portfolio with a slightly high proportion of emerging-country index funds according to an algorithm for handling mainly index funds for an investment period of ten years”, and the combinations of algorithms 13 and portfolios are given scores and ranked according to the degree of matching the condition.

The list of ranked combinations of algorithms 13 and portfolios is returned to the investment management application 22 and suggested to the user. The user can select a desired combination of algorithm 13 and portfolio from the list to conduct investment management suited to themselves. The top combination in the list may be automatically selected and used.

The list returned to the investment management application 22 may include all the ranked combinations of algorithms 13 and portfolios or include limited combinations at a predetermined rank and higher or with predetermined scores and more. In the embodiment, the portfolio types according to individual algorithms 13 are created in advance as the portfolio types 16 and the combinations of algorithms 13 and portfolios included in these types are collectively ranked. However, the investment management proposal system is not limited to this method. For example, first, the algorithms 13 matching the user's investment type may be ranked to select and decide target algorithms 13, and then the portfolios may be ranked according to the target algorithms 13 matching the user's investment type to select and decide target portfolios.

As described above, according to the investment management proposal system 1 in an embodiment of the present invention, the investment management assistance server 10 is configured to release and provide a plurality of kinds of usable investment management algorithms 13 implemented in the form of the investment management API 12 to the financial institutions 20 and others. In each of the financial institutions 20, the investment management application 22 can invoke the investment management API 12 according to the algorithms 13 recommended by the investment management assistance server 10 to respond flexibly to users' various needs and use the suitable algorithms 13.

In the embodiment, the vendors 30 and the like can develop new algorithms 13 using the released information resource API 14 from which the information relating to investment histories accumulated in the analysis DWH 15 can be used, and add the new algorithms 13 to the lineup of the investment management API 12. Then, the financial institutions 20 can invoke a plurality of different kinds of algorithms 13 provided by the vendors 30 to the investment management assistance server 10 in the form of the investment management API 12 from the investment management application 22 operated by themselves. That is, the investment management proposal system 1 in the embodiment is not a mere portfolio advising tool to the user but also serves as a matching platform for the financial institutions 20 selling investment products and the vendors 30 proposing methods for promoting sales of investment products.

The invention devised by the inventor has been specifically described so far based on the embodiment. However, it is needless to say that the present invention is not limited to the foregoing embodiment but can be modified in various manners without deviating from the gist of the present invention. For example, the foregoing embodiment has been described in detail for the ease of understanding the present invention, and the present invention is not necessarily limited to the embodiment including all the components described above. In addition, some of the components of the foregoing embodiment can be added to another embodiment, deleted, or replaced by those of another embodiment.

The present invention is applicable to an investment management proposal system that assists financial institutions and the like in offering advice and proposals on investment to investors.

What is claimed is:

1. An investment management proposal system that offers proposals for investment management of financial products to a user, comprising:
a plurality of kinds of pre-registered algorithms relating to investment management and capable of being invoked from a program; and
a determination engine that accepts an input of information relating to an investment stance from the user and selects preferred one or more of the algorithms based on the input information on the investment stance.

2. The investment management proposal system according to claim 1, further comprising
an analysis data holding unit that holds information on investment history of the user, wherein
the determination engine selects the algorithm based on the information on the investment stance input by the user and the information on the investment history of the user acquired from the analysis data holding unit.

3. The investment management proposal system according to claim 1, wherein the determination engine further selects a portfolio according to the algorithm based on the information on the investment stance input by the user.

4. The investment management proposal system according to claim 3, further comprising
an analysis data holding unit that holds information on investment history of the user, wherein
the determination engine selects the portfolio according to the algorithm based on the information on the investment stance input by the user and the information on the investment history of the user acquired from the analysis data holding unit.

5. The investment management proposal system according to claim 3, further comprising
an analysis data holding unit that holds information on investment history of the user, wherein
the determination engine corrects the selected portfolio based on a difference between the investment stance input by the user and the information on the actual investment history of the user.
